(19) United States
(12) Patent Application Publication
(10) Pub. No.: US 2010/0215804 A1
(43) Pub. Date: Aug. 26, 2010

(54) FOOD PRODUCT SUITABLE FOR PERSON WHO HAS DIFFICULTY IN CHEWING OR SWALLOWING

(76) Inventors: Reika Goto, Iwate (JP); Ryo Takei, Iwate (JP); Ken Kitamura, Tokyo (JP); Ken-ichirou Sugimura, Iwate (JP); Minoru Kuribayashi, Iwate (JP)

Correspondence Address: BIRCH STEWART KOLASCH & BIRCH, PO BOX 747, FALLS CHURCH, VA, 22040-0747, US

(21) Appl. No.: 12/681,233

(22) PCT Filed: Sep. 30, 2008
(86) PCT No.: PCT/JP2008/002740

§ 371 Date: Apr. 1, 2010

(30) Foreign Application Priority Data
Oct. 2, 2007 (JP) 2007-258797
Dec. 19, 2007 (JP) 2007-327160
Dec. 28, 2007 (JP) 2007-340457

(51) Int. Cl. A23L 1/30; A23L 1/28; A23L 1/314; A23L 1/325

(52) U.S. Cl. 426/56; 426/61; 426/63; 426/64

(57) ABSTRACT

A food product that is suitable for an elderly person or a person who has difficulty in chewing or swallowing is obtained by impregnating a material with an enzyme, said food product having a smooth texture and sufficient softness to be crushed by the gums or tongue in the mouth, while maintaining the natural shape and color of the material. The food product has a compressive strength of 5×10⁴ N/m² or lower when measured at a compression rate of 10 mm/sec by using a plunger with a diameter of 3 mm and setting the clearance at 30% of the thickness of the specimen.

### TECHNICAL FIELD

The present invention relates to food products that are suitable for an elderly person or a person who has difficulty in chewing or swallowing, and methods of producing the said food products. More specifically, the present invention relates to mushroom food products, plant food products and animal food products having the said property, and methods of producing these food products.

### BACKGROUND ART

Along with the advent of an aging society, the number of people who have difficulty in chewing or swallowing due to aging is increasing. These people with the chewing or swallowing problems take eater-friendly meals prepared by finely cutting regular food, or paste-like meals prepared by using a mixer. Since such a meal has a shape and color differing from those of a normal meal and its contents are not visually identifiable, it is unappetizing and hardly enjoyable.

As a method of producing a plant food product that has softness and smooth texture while maintaining the shape of the plant material, a softening method that comprises freezing and thawing of the plant material and subsequent introduction thereto of the enzymes under reduced pressure has been developed (see Patent Documents 1 and 2, for example). According to this method, the plant material is impregnated with a cellulolytic enzyme, a protopectic (protopectin-degrading) enzyme, a pectic enzyme, a hemicellulolytic (hemicellulose-degrading) enzyme, or the like, and subjected to an enzyme reaction at a pH of 4 to 6 and a temperature of 20 to 60° C. A plant food product that has been softened by this method can maintain the shape of the material, but cannot preserve the natural tone of color of the material, suffering discoloration such as fading.

It has been known that the tone of color of a plant material may be preserved by utilizing ferulic acid or an alkali metal salt thereof to prevent the discoloration of chlorophyll (i.e. green vegetable pigment). The addition of an organic acid salt or an inorganic acid salt having a buffering effect for adjusting the pH to 4.5 to 8 has also been described (see Patent Document 3, for example).

Although a softened plant food product preserving its tone of color may be prepared by these methods, when the product is frozen and then thawed, it substantially increases its hardness, gains sponge-like elasticity, and becomes so tough that it can no longer be crushed by the tongue. Moreover, since a significant change in color (fading) occurs during storage in a freezer or a refrigerator, the plant food product loses its appetizing color and cannot be provided as a suitable food product for an elderly person or a person who has difficulty in chewing or swallowing.

Moreover, the above food softening method is not suitable for mushrooms. Mushrooms are softened by a cooking process such as steaming, boiling and frying, but their tissues still do not collapse when pressed by the tongue due to their elasticity.

This is because the hyphae that form the mushroom fruit bodies are enclosed by hard cell walls that contain chitin as the main component. Chitin is an insoluble substance that is not dissolved or broken down by heating. Chitinous matters cannot be broken down or softened even by an enzyme such as cellulolytic enzyme, hemicellulolytic enzyme, pectic enzyme, or protease.

Mushrooms are relished by many and used in the dishes favored by elderly people, e.g. Chawan-mushi (savory steamed egg custard), Nimono (simmered food in sauce), and Chirashi-Zushi (unrolled sushi). However, since mushroom food products prepared by conventional cooking or processing methods are difficult to chew or swallow and thus deemed dangerous, a mushroom food product is rarely served to an elderly person or a person who has difficulty in chewing or swallowing. A method that completely decomposes a mushroom using an enzyme to obtain a porridge-like material (see Patent Document 4, for example) has been described. However, a mushroom food product that maintains its shape and has softness and smooth texture cannot be obtained by such a method.

Animal food products have also been typically served as finely chopped preparations by using a food processor, a mixer or the like, or as paste-like preparations. The tissues of meat or seafood may be softened while maintaining their shape by utilizing a partial tissue destruction method (e.g. perforation), but this method has been prone to problems including the failure to obtain uniform tissues. Methods for softening meat by bringing the meat into contact with a protease have also been proposed. However, since the tissues are not uniformly impregnated with the enzyme solution in any of these methods including the contact method, the injection method, and the tumbling method (see Patent Document 5, for example), the tissues are only partially softened and smooth texture cannot be obtained over the entire tissues.

Patent Document 1: JP-A-2003-284522

Patent Document 2: JP-A-2004-89181

Patent Document 3: Japanese Patent No. 338722

Patent Document 4: JP-A-H09-275927

Patent Document 5: JP-T-2003-508084

### SUMMARY OF INVENTION

### Problems to be Solved by the Invention

The objective of the present invention is to provide a food product that is suitable for an elderly person or a person who has difficulty in chewing or swallowing, and a method of producing the said food product.

### Means for Solving the Problems

The inventors of the present invention conducted extensive studies in order to achieve the above objective. As a result, the inventors found that a food product that is suitable for an elderly person or a person who has difficulty in chewing or swallowing, having smooth texture and sufficient softness to be crushed by the gums or tongue in the mouth, while maintaining the natural shape and tone of color of the material, can be obtained by impregnating and treating a material with an enzyme. This finding has led to the completion of the present invention.

In producing the mushroom food product which is one of the food products comprised in the present invention, it is possible to uniformly hydrolyze chitin and the like in the entire mushroom fruit bodies to an extent that the shape of the fruit bodies are maintained, by impregnating and treating the mushroom material with a chitinolytic (chitin-degrading) enzyme. This makes it possible to provide a mushroom food product that maintains the mushroom's original shape but easily collapses when pressed with a spoon or the like, crushes against the gums or tongue in the mouth, and when mixed with saliva forms a manageable chunk that can be easily swallowed. Since the mushroom food product according to the present invention passes through the pharynx at a moderate speed, it prevents misswallowing and does not stick to the respiratory tract opening, and therefore the mushroom food product of the present invention can be used in the dysphagia diet.

In producing the plant food product which is one of the food products comprised in the present invention, it has been found that a chelating agent along with the enzyme can be used for impregnating the plant material in order to prevent the polymerization mediated by chelate binding to the minerals present in the plant material. Subsequent quick freezing prevents the impregnated plant material from becoming tough even after thawing and also from gaining sponge-like fibrousness, allowing it to maintain the softness suitable for a person with a swallowing problem or other difficulty. It has also been found that, when the plant material gets softened, impregnation with ferulic acid or a salt thereof in addition to the enzyme and the chelating agent allows the plant food product to maintain the physical properties, retain the softness and the smooth texture, and preserve the vivid tone of color, even when it is frozen and thawed.

Since the plant food product prepared according to the findings of the present invention has physical properties and colors that are stable even when stored at a low temperature for a prolonged period, it can be provided as a frozen food product that is suitable for an elderly person or a person who has difficulty in chewing or swallowing.

In producing the animal food product which is one of the food products comprised in the present invention, it has been found that the muscular tissues and the connective tissues of the material can be broken down to an extent that its overall shape is maintained, by first removing water from the material and then impregnating the material with a protease solution under reduced pressure. The animal food product thus produced has a smooth texture and softness that allows the food product to be crushed by the gums or tongue.

It has been found that, when the material has a dry surface and cannot be easily impregnated with the enzyme solution, an additional wetting process of the material in a high-humidity, high-temperature environment, corresponding to the temperature of 50 to 100° C. and the humidity of 70% or higher, improves the subsequent impregnation with the enzyme solution. It is effective to impregnate the material with a thickener together with the protease solution in order to improve the smoothness of the food product. Moreover, it has been found that the efficiency of the protease impregnation step can be improved by pre-digesting the surface of the animal material to generate minute openings thereon, by immersing the animal material in a protease solution or coating the animal material with protease-containing powder.

Since the animal food product prepared according to the findings of the present invention provides a food material in which the muscular tissues and the connective tissues are broken down to an extent that the overall shape is maintained, and has a smooth texture and sufficient softness to be crushed by the gums or tongue, it can be provided as a food product that is suitable for an elderly person or a person who has difficulty in chewing or swallowing.

The present invention provides the following.

(1) A food product that is suitable for an elderly person or a person who has difficulty in chewing or swallowing, obtainable by impregnating and treating a food material with an enzyme, said food product having a smooth texture and sufficient softness to be crushed by the gums or tongue in the mouth, while maintaining the natural shape and tone of color of the material.

(2) The food product suitable for an elderly person or a person who has difficulty in chewing or swallowing according to (1), wherein said food product has a compressive strength of 5×10⁴ N/m² or lower when measured at a compression rate of 10 mm/sec by using a plunger with a diameter of 3 mm and setting the clearance at 30% of the thickness of the specimen.

(3) The food product suitable for an elderly person or a person who has difficulty in chewing or swallowing according to (1) or (2), wherein said food product has a smooth texture and sufficient softness to be crushed by the gums or tongue in the mouth while maintaining the natural shape and tone of color of the material, even when it is further frozen and thawed.

(4) The food product suitable for an elderly person or a person who has difficulty in chewing or swallowing according to any of (1) to (3), wherein said food product is a mushroom food product, a plant food product, or an animal food product.

(5) The mushroom food product according to any of (1) to (4), obtainable by impregnating and treating a mushroom material with a chitinolytic enzyme.

(6) The mushroom food product according to (5), obtainable by impregnating and treating the mushroom material with an enzyme agent comprising a chitinolytic enzyme and a protease.

(7) The plant food product according to any of (1) to (4), obtainable by impregnating and treating a plant material with an enzyme, ferulic acid or a salt thereof, and a substance having a chelating effect.

(8) The plant food product according to (7), obtainable with an additional quick-freezing process.

(9) The plant food product according to (7) or (8), wherein the enzyme is at least one enzyme selected from a cellulolytic enzyme, a protopectic enzyme, a pectic enzyme, and a hemicellulolytic enzyme.

(10) The plant food product according to any of (7) to (9), wherein the substance having a chelating effect is at least one substance selected from citric acid, lactic acid, oxalic acid, and glycine.

(11) The plant food product according to any of (7) to (10), wherein the material is quickly frozen down in such a way that it transits from 0° C. to −5° C. within 15 minutes before it is further cooled down to −18° C. or below.

(12) The plant food product according to any of (7) to (11), wherein the plant material is impregnated with an aqueous solution that contains 0.01 to 10% enzyme and 0.1 to 20% ferulic acid or salt thereof.

(13) The animal food product according to any of (1) to (4), obtainable by removing water from an animal material consisting of meat or seafood, by 15% or more based on the fresh weight of the material, and impregnating and treating the material with an enzyme.

(14) The animal food product according to (13), obtainable by removing water from an animal material consisting of meat or seafood, by 15% or more based on the fresh weight of the material, then wetting the material in an environment having a temperature of 50 to 100° C. and humidity of 70% or higher, and impregnating and treating the material with an enzyme.

(15) The animal food product according to (13) or (14), wherein the surface of the animal material is pre-digested with an enzyme solution or enzyme-containing powder to generate minute openings thereon.

(16) The animal food product according to any of (13) to (15), wherein the enzyme is a protease.

(17) The food product suitable for an elderly person or a person who has difficulty in chewing or swallowing according to any of (1) to (16), obtainable by impregnating and treating the material with a solution that contains a thickener in addition to the enzyme.

(18) The food product suitable for an elderly person or a person who has difficulty in chewing or swallowing according to (17), wherein the thickener is at least one thickener selected from alginate, pectin, xanthan gum, guar gum, locust bean gum, carrageenan, glucomannan, curdlan, and starch.

(19) The food product suitable for an elderly person or a person who has difficulty in chewing or swallowing according to (17) or (18), wherein the solution that contains the thickener additionally contains trehalose.

(20) The food product suitable for an elderly person or a person who has difficulty in chewing or swallowing according to any of (1) to (19), wherein the said food product is a mushroom food product, a plant food product or an animal food product that is impregnated with a functional food component for nutritional enhancement.

(21) A method of producing a mushroom food product comprising the step of transforming the surface and the inside of a mushroom material into a soft or gel-like matter by impregnating and treating the mushroom fruit body with an enzyme or an enzyme and a thickener.

(22) The method of producing a mushroom food product according to (21), wherein the enzyme is a chitinolytic enzyme.

(23) A method of producing a plant food product comprising the steps of impregnating a plant material with an enzyme, ferulic acid or a salt thereof, and a substance having a chelating effect, and quick-freezing the said plant material.

(24) The method of producing a plant food product according to (23), wherein the quickly-freezing is performed in such a way that the plant material transits from 0° C. to −5° C. within 15 minutes before it is further cooled down to −18° C. or below.

(25) The method of producing a plant food product according to (23) or (24), wherein the plant material is impregnated with an aqueous solution that contains 0.01 to 10% enzyme and 0.1 to 20% ferulic acid or salt thereof.

(26) The method of producing a plant food product according to any of (23) to (25), wherein the enzyme is at least one enzyme selected from a cellulolytic enzyme, a protopectic enzyme, a pectic enzyme, and a hemicellulolytic enzyme.

(27) A method of producing an animal food product comprising the steps of removing water from an animal material consisting of meat or seafood, by 15% or more based on the fresh weight of the material, and subsequently impregnating and treating the material with an enzyme.

(28) The method of producing an animal food product according to (27), comprising the steps of removing water from an animal material consisting of meat or seafood, by 15% or more based on the fresh weight of the material, then wetting the material in an environment having a temperature of 50 to 100° C. and humidity of 70% or higher, and impregnating the material with an enzyme.

(29) The method of producing an animal food product according to (27) or (28), wherein the material is impregnated with the enzyme and a thickener.

(30) The method of producing an animal food product according to any of (27) to (29), wherein the surface of the animal material is pre-digested with an enzyme solution or enzyme-containing powder to generate minute openings thereon.

(31) The method of producing an animal food product according to any of (27) to (30), wherein the enzyme is a protease.

### EFFECTS OF THE INVENTION

The present invention has made it possible to provide a food product (e.g. mushroom food product, plant food product, and animal food product) that is suitable for an elderly person or a person who has difficulty in chewing or swallowing.

Mushrooms are difficult to chew and also difficult to swallow since mushrooms are hardly breakable in the mouth. The present invention, however, has made it possible to provide a mushroom food product that maintains the mushroom's original shape, taste, color and flavor, is soft and smooth, and can be easily crushed and swallowed in the mouth, without finely cutting the mushroom material or processing it into a paste-like material.

The present invention has also made it possible to provide a plant food product wherein a loss/change of color and a deterioration of texture in the processing, during storage, or after defrosting, are suppressed. Since the plant food product according to the present invention has a normal shape and preserves natural colors (e.g. green), it can provide an appetizing and tasty meal.

The present invention has also made it possible to provide an animal food product made of common meat or seafood that is softened and still maintains the material's original appearance and texture.

### DESCRIPTION OF EMBODIMENTS

The “food products that are suitable for an elderly person or a person who has difficulty in chewing or swallowing” according to the present invention can include any food product that is obtainable by impregnating and treating a material with an enzyme and has a smooth texture and sufficient softness to be crushed by the gums or tongue in the mouth while maintaining the natural shape and tone of color of the material. The food product according to the present invention preferably has a compressive strength of 5×10⁴ N/m² or lower when measured at a compression rate of 10 mm/sec by using a plunger with a diameter of 3 mm and setting the clearance at 30% of the thickness of the specimen. It is particularly preferable that the food product according to the present invention be easily taken by an elderly person or a person who has difficulty in chewing or swallowing, have a shape and a color similar to those of a normal food, and be appetizing and tasty.

Further, the “food product that is suitable for an elderly person or a person who has difficulty in chewing or swallowing” according to the present invention preferably has a smooth texture and sufficient softness to be crushed by the gums or tongue in the mouth while maintaining the natural shape and tone of color of the material, even when it is frozen and thawed.

The term “natural shape” used to describe the food product that is suitable for an elderly person or a person who has difficulty in chewing or swallowing according to the present invention is intended to mean having a similar form, external state and appearance as those found in the original material before it is manufactured into the product (based on the definition of “shape”, namely “form, external state and appearance”, according to the Daijirin Dictionary, second edition, Sanseido Publishing Co., Ltd.).

In the present invention, each food product has been visually inspected, and the extent of its “natural shape” has been evaluated according to the five-grade system (5 points: the food product has a natural shape, 4 points: the food product has a sufficiently natural shape although a small change is observed, 3 points: the food product has a moderately changed shape that is no longer considered natural, 2 points: the food product has an obviously changed shape that is not natural, 1 point: the food product has a substantially changed shape (disintegration, crumbling).

The term “natural tone of color” used to describe the food product that is suitable for an elderly person or a person who has difficulty in chewing or swallowing according to the present invention is intended to mean having a similar combination, shade, intensity and hue of colors as those found in the original material before it is manufactured into the product (based on the definition of “tone of color”, namely “combination, shade, intensity and hue of colors”, according to the Daijirin Dictionary, second edition, Sanseido Publishing Co., Ltd.).

In the present invention, each food product has been visually inspected, and the extent of its “natural tone of color” has been evaluated according to the five-grade system (5 points: the food product has a natural tone of color, 4 points: the food product has a sufficiently natural tone of color although a small change is observed, 3 points: the food product has a moderately changed tone of color that is no longer considered natural, 2 points: the food product has an obviously changed tone of color that is not natural, 1 points: the food product has a substantially changed tone of color (discoloration, fading).

The term “softness” used to describe the food product that is suitable for an elderly person or a person who has difficulty in chewing or swallowing according to the present invention is intended to mean the quality that allows the food product to be easily crushed when pressed by the gums or tongue in the mouth (based on a definition of “softness”, namely “fluffiness”, according to the Daijirin Dictionary, second edition, Sanseido Publishing Co., Ltd.).

In the present invention, as a way of quantitatively defining softness, the food product is considered to be “soft” when the food product has a measurement value of 5×10⁴ N/m² or less when measured by the method described in “Handling of the Indication Approvals for the Foods for the Elderly (Feb. 23, 1994, Eishin Vol. 15, the Ministry of Health and Welfare of Japan)”, in which 5×10⁴ N/m² is indicated as a standard value for a solid material that can be crushed by the tongue or gums.

Furthermore, the “softness” has been evaluated by grading the sensation of “softness” felt when the food product is crushed by the tongue or gums according to the five-grade system (5 points: very soft, 4 points: soft, 3 points: not necessarily soft, 2 points: not soft (somewhat hard), 1 point: not soft at all (very hard)).

The term “smooth” used to describe the texture of the food product that is suitable for an elderly person or a person who has difficulty in chewing or swallowing according to the present invention is intended to mean the quality of being devoid of grittiness or stickiness on the surface, giving a slippery sensation in the mouth, and sliding easily on the tongue or in the pharynx before and after mastication (based on the definition of “smooth”, namely “having even and sleek surface, slippery, slidable”, according to the Daijirin Dictionary, second edition, Sanseido Publishing Co., Ltd.).

In the present invention, the “smoothness” has been evaluated by grading the sensation of “smoothness” felt when the food product is rolled by the tongue and masticated in the mouth, and when the masticated chunk is swallowed, according to the five-grade system (5 points: very smooth, 4 points: smooth, 3 points: not necessarily smooth, 2 points: not smooth (somewhat rough), 1 point: not smooth at all (very rough)).

Examples of the materials used for the food products according to the present invention include mushroom materials (e.g. Shiitake mushroom, Buna-Shimeji (brown beech mushroom) and Maitake mushroom), plant materials (e.g. broccoli and carrot), animal materials (e.g. meat and fish) and the like. The enzyme with which the material is impregnated for producing the food product can be any enzyme appropriate for the specific material, insofar as it enables the preparation of a “food product that is suitable for an elderly person or a person who has difficulty in chewing or swallowing” according to the present invention.

The “food product that is suitable for an elderly person or a person who has difficulty in chewing or swallowing” according to the present invention also includes a food product obtainable by impregnating and treating the material with a solution that contains a thickener together with the enzyme.

Examples of the thickeners that may be used include any edible thickeners such as alginate, pectin, xanthan gum, guar gum, locust bean gum, carrageenan, glucomannan, curdlan, and starch. These thickeners may be used either individually or in combination.

The solution that contains the thickener may additionally contain trehalose. Any trehalose may be used, for example those commercially available from Hayashibara Shoji, Inc. and other companies.

Nutritional ingredients such as amino acids (e.g. arginine and glutamine), minerals, and vitamins may also be used. When adding glutamine as an aqueous solution, a stable gluten hydrolysate may be used.

The “mushroom food product”, which is one of the “food products suitable for an elderly person or a person who has difficulty in chewing or swallowing”, may be any product suitable for an elderly person or a person who has difficulty in chewing or swallowing that is obtainable by impregnating and treating the mushroom material with an enzyme agent comprising a chitinolytic enzyme.

Examples of the mushroom materials that may be used in the present invention include, but are not limited to, Shiitake, Shimeji, Maitake (Hen of the Woods), Kikurage, Matsutake (pine mushroom), Enokidake (golden needle mushroom), truffle, Eringi (king oyster mushroom), button mushroom and Nameko. These mushroom materials may be raw, cooked, or dried.

The method for producing the “mushroom food product” according to the present invention may be any method that involves impregnating and treating the mushroom material with an enzyme for obtaining a mushroom food product suitable for an elderly person or a person who has difficulty in chewing or swallowing.

In the enzyme treatment, it is important to uniformly hydrolyze the chitin components that connect the cell walls in the entire fruit body so that the preparation achieves a preferable compressive strength. Furthermore, in conjunction with the chitin hydrolysis, it is preferable to uniformly and moderately hydrolyze the proteins in the entire mushroom since this achieves significant softening of the mushroom material.

Furthermore, impregnation or coating with thickening and/or gelling agents in conjunction with the hydrolysis of chitin and other components may enable the production of a mushroom food product that has a jelly-like texture while maintaining the original shape of the mushroom material, forms a manageable chunk when mixed with saliva which can pass through the pharynx at a moderate speed, prevents misswallowing, and does not stick to the respiratory tract opening.

Thus, it is preferable that the method of producing the “mushroom food product” according to the present invention include the step of uniformly hydrolyzing the chitin components contained in the entire mushroom material, or uniformly hydrolyzing the chitin components and the proteins at the same time in the entire mushroom material, wherein appropriate hydrolyses give the material a compressive strength of 5×10⁴ N/m² or lower when measured at a compression rate of 10 mm/sec by using a plunger with a diameter of 3 mm and setting the clearance at 30% of the thickness of the specimen. The above step may be implemented by impregnating the material with a chitinolytic enzyme, or a combination of a chitinolytic enzyme and a protease, under appropriate conditions.

The above step may also be implemented by a chemical treatment involving impregnation of the material with an acid or a base. However, since the treatment with an acid or a base may cause a marked deterioration of the flavor of the mushroom, the method by enzyme treatment is especially preferable.

When a thickener or gelling agent is used for impregnating or coating the mushroom material, the mushroom material may be impregnated with an acid, base, or enzyme solution that additionally contains the thickener or gelling agent, or, it may be first softened by the enzyme treatment step and subsequently subjected to the impregnation or immersion step with a thickener or gelling agent solution. In order to uniformly impregnate the entire mushroom material with the enzyme solution and/or the thickener, the mushroom material is preferably heat-treated in water or steamed, then frozen once and thawed, before it is impregnated.

The following descriptions are provided to explain in further detail the methods of producing the mushroom food products according to the present invention.

(1) After a raw or dried mushroom material is heated in water or steamed, it is uniformly impregnated with (or immersed in or injected with), preferably a chitinolytic enzyme solution, or a solution containing a mixture of a chitinolytic enzyme and a protease, and allowed to stand at an appropriate temperature for an appropriate period of time so that the mushroom food product achieves a compressive strength of 5×10⁴ N/m² or lower when measured at a compression rate of 10 mm/sec by using a plunger with a diameter of 3 mm and setting the clearance at 30% of the thickness of the specimen. The mushroom material may be more uniformly impregnated with the solution if it is subjected to heating in water or steaming, followed by freezing/thawing or no freezing, and then immersing in the solution under an elevated- or reduced-pressure environment. Freezing, especially, is preferable because it will create numerous pores within the mushroom material due to the formation of ice crystals, enabling highly uniform impregnation with the enzyme solution. Further, the addition of trehalose at a concentration of 0.1 to 30% to the impregnation solution improves the retention of the solution within the mushroom material, and hence the effectiveness of softening, and is therefore preferable.

(2) The mushroom material is impregnated with a solution that contains 0.1 to 10% thickener, in addition to and at the same time as the solution used in (1). Alternatively, the mushroom material is first softened by (1) and subsequently immersed in or impregnated with the solution that contains 0.1 to 10% thickener.

(3) Supplementary ingredients such as functional food components, flavoring components, other food additives, pharmaceutical components, therapeutic agents and other appropriate ingredients are dissolved or dispersed in the impregnation solution in (1) or (2), and the surface and the inside of the mushroom material are impregnated with these ingredients.

(4) When alginate or pectin is used as a thickener, the food material is immersed in a solution containing calcium ion at a concentration of 0.01 to 5% in addition to the said thickener, under a normal pressure, elevated pressure or reduced pressure, and the surface and the inside of the material are impregnated with the solution and allowed to become soft or gel-like.

(5) The mushroom material described above is placed in a container, optionally with other materials as needed, and cooked. Further, a solution containing a thickener, or a solution containing a thickener, seasoning and other ingredients, is optionally added before/during cooking.

Examples of the enzymes that may be used in the method of producing the mushroom food product according to the present invention include, but are not limited to, a chitinolytic enzyme, an enzyme having a chitinolytic enzyme activity, an enzyme agent that contains a chitinolytic enzyme, and the like. Examples of the sources of the enzymes include, but are not limited to, genus Trichoderma, genus Bacillus, and genus Aspergillus. Commercially available enzymes such as chitinase (SIGMA) may also be used. The amount of enzyme used is not limited to any specific quantity, but it is preferable to prepare a 0.05 to 10% enzyme solution for the impregnation, or inject an amount of the enzyme corresponding to 0.01 to 5% of the weight of the mushroom.

The protease, which may be optionally included, also is not limited to any specific type, and examples include the proteases of plant-origin (e.g. papain and bromelin), proteases of microorganism-origin (e.g. proteases of the genus Bacillus and genus Aspergillus), and proteases of animal-origin (e.g. pepsin and pancreatin). The amount of the protease used is not limited to any specific quantity, but it is preferable to prepare a 0.05 to 10% protease solution for the impregnation, or inject an amount of the protease corresponding to 0.01 to 5% of the weight of the mushroom.

Examples of the methods that may be used for uniformly impregnating an entire mushroom material include, but are not limited to, immersion, injection using a syringe or the like, and impregnation under a vacuum, reduced pressure, or elevated pressure. Impregnation under a reduced pressure is especially preferable, and in this case, a reduced pressure of 500 to 20,000 Pa, preferably 500 to 4,000 Pa, is used. The pressure reduction may be accomplished by using a vacuum or decompression pump device such as a vacuum kneader and rotary vacuum tank, or a chamber/apparatus capable of decompression such as an aspirator. Following the heat-treatment, it is particularly preferable to freeze and thaw the mushroom prior to the impregnation with the enzyme solution, because the formation of ice crystals during freezing and their dissipation after thawing induce the formation of numerous pores within the mushroom material which enables thorough and uniform impregnation.

Any appropriate conditions for the enzyme hydrolysis treatment may be employed, and the temperature, time, and pH are so chosen that the mushroom food product achieves a compressive strength of 5×10⁴ N/m² or lower when measured at a compression rate of 10 mm/sec by using a plunger with a diameter of 3 mm and setting the clearance at 30% of the thickness of the specimen. Such appropriate conditions may include a reaction temperature of 5 to 60° C., a reaction time of 1 to 72 hours, and a pH of 4 to 8. The hydrolysis reaction continues even if the mushroom material is left in a refrigerator (about 5° C.) for 12 to 72 hours after the impregnation.

The concentration of the thickener optionally used in the impregnation may be adjusted as needed depending on the type of the thickener and the material, for example 0.1 to 5% when using an alginate, 0.05 to 5% when using pectin, 0.1 to 10% when using xanthan gum, 0.1 to 5% when using guar gum, 0.05 to 10% when using locust bean gum, 0.05 to 20% when using carrageenan, 0.02 to 5% when using glucomannan, 0.2 to 19% when using curdlan, and 0.05 to 20% when using a starch. When using two or more thickeners, the concentration of each may be reduced as needed.

It is preferable that the thickener used in the method of producing the mushroom food product according to the present invention be relatively viscoelastic. Among different thickeners, agar and gellan gum (a polysaccharide thickener) are not preferable because, when jellified, they become fragile and tend to lose water, and their shape-holding capacities consequently become unstable.

When adding trehalose to the thickener-containing solution, it is preferable to add trehalose at a concentration of 0.1 to 20% so that the surface and the inside of the material are impregnated with trehalose together with the thickener.

Trehalose helps to suppress degradation of the nutritional components, functional food components and other ingredients, aging of the starch, and changes in taste, smell, and color. Even though trehalose is a low-molecular-weight carbohydrate consisting of a disaccharide, it has a very high water retention capacity, and it therefore promotes impregnation of the mushroom material with the softening-agent solution described above and also improves the retention of the said solution within the material after impregnation. Moreover, trehalose itself can easily infiltrate the mushroom material, helps to retain water within the mushroom material, and promote the infiltration of the thickener into the material. After the material has been impregnated with the thickener, trehalose effectively prevents a leakage of the thickener from the mushroom material through its interaction with the thickener. Since trehalose also has an effect for maintaining the higher-order polysaccharide structure of the mushroom material, trehalose preserves the mushroom food product in a natural state together with the infiltrated thickener, bringing out the visual and sensuous attractiveness (including the color) of the food product. These features are especially useful if the mushroom food product is a frozen product, because trehalose prevents a change in shape of the mushroom food product upon defrosting and also prevents a release or leakage of water from the mushroom food product.

Nutritional ingredients (e.g. carbohydrates, proteins, lipids, dietary fibers, vitamins, minerals, and the hydrolysates thereof), functional ingredients (phytochemicals) (e.g. polyphenols, carotenoids, sulfur compounds, terpenes, and β-glucan), flavoring ingredients (e.g. agents that provide sweetness, saltiness, bitterness, sourness or spiciness), other food additives, pharmaceutical ingredients, and/or therapeutic agents may be dissolved or dispersed in the thickener-containing solution and infiltrated into the surface and the inside of the mushroom material. New types of medical foods may also be prepared this way.

The mushroom food product thus produced may be packed in a pouch or a cup and subjected to heat sterilization or other treatments if needed. Since starch softens or gels upon heating, the heat sterilization may be performed at the same time as the softening/gelling process.

For the plant food product which is one of the “food products suitable for an elderly person or a person who has difficulty in chewing or swallowing” of the present invention, the plant materials that may be used are not limited to any specific types of plants. The examples include, but are not limited to, leaf and stem vegetables (e.g. broccoli, spinach, cabbage and Komatsuna (Japanese mustard spinach)), fruit vegetables (e.g. bell pepper, cucumber and pumpkin), root vegetables (e.g. carrot and Daikon radish), beans (e.g. pea and green soybean), and potatoes (e.g. sweet potato). These plant materials may be raw, blanched (e.g. heat-treated in boiling water for five minutes), or dried.

The type and concentration of the enzyme and the reaction time used for softening the plant material may vary depending on the type of the plant to be processed, but it is preferable to dissolve 0.01 to 10 g of the enzyme in 100 ml of a buffer or other solvent. The solvent may be any appropriate solvent that is capable of maintaining the pH of the solution suitable for the enzymatic activity during the reaction.

Examples of ferulic acid and salts thereof include ferulic acid, sodium ferulate and potassium ferulate. The ferulic acid or a salt thereof should be added at a concentration that is effective for preventing discoloration, and the appropriate concentration varies depending on the plant material to be processed, but it is preferable to dissolve 0.1 to 20 g of ferulic acid or a salt thereof in 100 ml of a solvent, for example. Ferulic acid or a salt thereof and the enzyme described above may be dissolved together, or they may be prepared separately and used separately, but dissolving them together before impregnation is preferable from the efficiency point of view.

The chelating agent may be any substance having a chelating effect, and the examples include, but are not limited to, citric acid, lactic acid, oxalic acid and glycine. The concentration of the chelating agent used should be such as not to adversely affect the flavor of the food. It is preferable to dissolve 0.01 to 10 g of the chelating agent in 100 ml of a solvent, for example. The chelating agent may be dissolved together with the enzyme and/or ferulic acid and used together for impregnating the plant material, or it may be dissolved and used separately from the enzyme and/or ferulic acid. It is preferable from the efficiency point of view to impregnate the plant material with the chelating agent together with the enzyme and/or ferulic acid.

Functional food components such as amino acids may also be added in the impregnation process for nutritional enhancement. For example, if the material is impregnated with 0.5 g or more arginine and 0.75 g or more glutamine per piece of the food product, one can take about 1200 ml liquid diet (the minimum daily usage) worth of these amino acids by eating 12 pieces of the food product. The amount of the minerals and/or vitamins per piece may be adjusted between ⅙th of the estimated average requirement and the maximum limit described in “The Dietary Intake Standards for the Japanese People (2005)”, so that one can take the amount that is at least more than minimally required and at most less than maximally allowed by eating 6 to 1 pieces of the food product. For example, if the enhanced components are copper, zinc, vitamin B1, vitamin B12 and vitamin C, their concentrations may be adjusted to 0.3 to 3 mg, 3.0 to 30 mg, 0.36 to 3.6 mg, 0.64 to 6.4 ng and 0.2 to 2 g per piece of the plant material, respectively. These amounts are equivalent to 200 to 2000 ml of a commercially available liquid diet.

These functional enhancement components may be dissolved and used separately from the ferulic acid or salt thereof, the chelating agent and the enzyme, but it is preferable to dissolve them together with these other components and let them infiltrate simultaneously into the plant material, for easiness and efficiency of the operation.

The plant food product according to the present invention may be distributed frozen, and defrosted at the stores or by the consumers. It is also possible to provide the food product, with appropriate flavoring, as a frozen dessert that is eaten while still frozen and characterized by smooth crushing/melting in the mouth. Appropriate flavoring for a frozen dessert may comprise addition of an appropriate amount of saccharide (e.g. sucrose, isomerized sugar and starch syrup), artificial sweetener, souring agent (e.g. citric acid), flavoring agent, and the like.

The saccharide, artificial sweetener, souring agent, flavoring agent and the like may be dissolved and used separately from the ferulic acid or salt thereof, the chelating agent and the enzyme, but it is preferable to dissolve them together with these other components and let them infiltrate simultaneously into the plant material, for easiness and efficiency of the operation.

The method for producing a “plant food product” according to the present invention may be any suitable method that involves impregnation and treatment of a plant material with an enzyme, ferulic acid or a salt thereof and a chelating agent, and quick-freezing of the plant material, for obtaining a plant food product suitable for an elderly person or a person who has difficulty in chewing or swallowing. It is preferable to impregnate the plant material with an aqueous solution that contains 0.01 to 10% enzyme and 0.1 to 20% ferulic acid or salt thereof for performing the enzyme reaction.

The following descriptions are provided to explain in further detail the methods of producing the plant food products according to the present invention.

The plant material is heated in boiling water first, frozen, and thawed before it is impregnated with the enzyme and other components. The plant material is then immersed in an aqueous solution that contains the enzyme, the ferulic acid or salt thereof, the chelating agent and the functional food components, and subjected to decompression. The reduced pressure is preferably 500 to 20,000 Pa so that the plant material is thoroughly impregnated with the aqueous solution. The decompression time is not limited to any specific length, but is preferably 2 to 60 minutes. The plant food product can be supplied with a flavor desirable for a frozen dessert, by adding sugar, sweetener and/or flavor essence to the aqueous solution that contains the enzyme and other components. The plant food material is then removed from the aqueous solution that contains the enzyme etc., and allowed to undergo the enzyme reaction. The enzyme reaction may be carried out in any suitable conditions and may be appropriately adjusted depending on the type of material and the desired degree of softening. Preferably, the reaction is left to proceed, undisturbed, at a temperature of 0 to 60° C. for 1 to 48 hours. The enzyme reaction can also be carried out in a refrigerator (5° C.) for 8 to 48 hours.

The enzymes used in the method of producing the plant food product according to the present invention may be one or more enzymes selected from a cellulolytic enzyme, a protopectic enzyme, a pectic enzyme, and a hemicellulolytic enzyme. Examples of these enzymes include, but are not limited to, those available from the commercial sources such as Amano Enzyme Inc.

In the quick-freezing step in the method of producing the plant food product according to the present invention, the material is preferably frozen in such a way that it transits from 0° C. to −5° C. within 15 minutes before it is further cooled down to −18° C. or below. This may be accomplished by using a freezing equipment such as Blast Chiller (manufactured by Fukushima Industries Corp.), liquid nitrogen, cold alcohol, or the like. This quick-freezing limits the time the material spends in 0 to −5° C., which is the temperature range in which ice crystals form, and thus minimizes ice crystal formation within the material, and is therefore effective for preventing a shape change and water loss, as well as for preventing impairment of the effect of the ferulic acid or salts thereof caused by disintegration of the tissues.

The “animal food product” which is one of the “food products that are suitable for an elderly person or a person who has difficulty in chewing or swallowing” of the present invention, may be any product that is obtainable by removing water from an animal material (consisting of meat or seafood) by 15% or more based on the fresh weight of the material and impregnating and treating the material with an enzyme, and is suitable for an elderly person or a person who has difficulty in chewing or swallowing.

Examples of the animal materials that may be used in the present invention include, but are not limited to, meat such as chicken, pork, and beef, and seafood such as fish, squid, octopus, and shellfish. These animal materials may be raw, cooked, or a dried.

The method used for producing the “animal food product” according to the present invention may be any appropriate method that involves removal of water from an animal material (consisting of meat or seafood) by 15% or more based on the fresh weight of the material, and impregnation and treatment of the material with an enzyme, for making it suitable for an elderly person or a person who has difficulty in chewing or swallowing. For example, the animal material may be subjected to water removal by 15% or more based on the fresh weight, wetted in the environment having a temperature of 50 to 100° C. and humidity of 70% or higher, and impregnated and treated with an enzyme or a combination of an enzyme and a thickener. The “animal food product” according to the present invention may also be produced by using an animal material whose surface has been pre-digested by an enzyme solution or enzyme-containing powder to generate minute openings thereon.

In the method of producing the “animal food product” according to the present invention, it is possible to first reduce water in the animal material consisting of meat or seafood, uniformly infiltrate a protease solution into the entire material, digest the proteins contained in the muscular as well as connective tissues to an extent that the overall shape is maintained, and adjust the compressive strength of the material.

A smoother texture can be achieved by impregnating the material with a thickener together with the enzyme solution. The efficiency of the protease solution impregnation step may be improved by wetting the surface and the inside of the material, which has been previously subjected to water removal, in a high temperature/high humidity environment. The efficiency of the water removal step and the protease solution impregnation step may also be improved by immersing the food material in a protease solution or coating the food material with protease-containing powder in advance. In this case, the surface of the animal material is pre-digested to generate minute openings within the tissues, so that water can migrate more freely and the protease or polysaccharide solution also can gain easier access through the openings.

In the method of producing the animal food product according to the present invention, water may be removed from a meat or seafood material by thermal drying, hot-blast drying, cold-blast drying, freeze-drying, salting, centrifugation, capillary action, deep-frying, or the like. One or more methods may be selected from these methods depending on the type of the material.

When using the thermal drying method, the material is sealed in an airtight container, and heated to 50 to 90° C. in hot water or the like to drip water out of the material. When using the hot-blast drying or cold-blast drying method, the air with a temperature of 10 to 120° C., for example, is blown onto the material to vaporize the water. When using the freeze-drying method, the material is cooled to −20 to −80° C. and then decompressed to sublime the frozen water contained inside the material. When using the salting method, water is removed by bringing the material into contact with a 5% aqueous solution of the common salt or with slurry prepared by mixing the salt and water. When using the centrifugation method, a centrifugal food dehydrator or a similar equipment may be utilized. In this case, the material is put in a basket-like container and spun to remove the water. This may be accomplished, for example, by using the OKS-model gyro-balance-type centrifugal dehydrator (manufactured by Iwatsuki Kikai Seisakusho Co., Ltd.) at the centrifugal speed of 5,000 rpm for 10 minutes, but other equipments also may be used. When using the capillary action method, the food is placed between sheets of kitchen paper, for example, to remove the water. When using the deep-frying method, the material is heated in an edible oil at 70 to 180° C., for example, to vaporize and remove the water. Water should be removed from the material by 15% or more based on the fresh weight of the material. If the amount of the water removed is less than 15% based on the fresh weight of the material, the effect of the water removal will be unsatisfactory.

Examples of the enzymes with which the material is impregnated after the water reduction include proteases, peptic enzymes, collagenolytic proteases, enzyme agents containing such enzymes, and the like, that can hydrolyze the proteins in the muscular tissues and the connective tissues of the animal material consisting of meat or seafood to an extent that the overall shape of the material is maintained. Examples of these enzymes include, but are not limited to, the enzymes of microorganism-origin (e.g. genus Aspergillus and genus Bacillus), enzymes of plant-origin (e.g. papain, bromelin, and actinidine), and enzymes of animal-origin (e.g. pepsin and pancreatin). These enzymes may be added in any appropriate amount. It is preferable to impregnate the material with a 0.1 to 10% enzyme aqueous solution.

A preferred method for uniformly impregnating the entire animal material (meat or seafood) with the enzyme solution after the water reduction is a decompression treatment. The decompression treatment reduces the pressure to 500 to 20,000 Pa, preferably to 500 to 4,000 Pa. The decompression treatment may be performed by using a vacuum kneader, rotary vacuum tank, vacuum or decompression pump, or a chamber/apparatus capable of decompression such as an aspirator.

The material may be impregnated with a thickener together with the enzyme solution. When using a thickener that is insoluble at a low temperature (e.g. guar gum or carrageenan), it is preferable to first dissolve the thickener by heating, cool the solution down to a temperature (60° C. or lower) at which the enzyme would not be inactivated, and then mix the solution with the enzyme solution for impregnation.

The impregnation efficiency can be improved by wetting the surface of the animal material, consisting of meat or seafood with a reduced water content, in an environment with a temperature of 50 to 100° C. and humidity of 70% or higher before immersing the animal material in the enzyme solution. Equipment such as “Self Cooking Center” (manufactured by Rational Japan) may be used for this purpose.

The surface of the material can be pre-digested to generate minute openings between the tissues by bringing the animal material into contact with the enzyme solution or enzyme-containing powder, so that the efficiency of the water removal step and the enzyme/thickener impregnation step can be improved. When the food material is immersed in a protease solution or coated with protease-containing powder in advance, the surface of the animal material is digested and minute openings are generated between the tissues, which facilitates free water migration and hence improves the efficiency of the water removal step. Moreover, the protease or the polysaccharide solution can more easily infiltrate through the openings so that the efficiency of the impregnation step is also improved.

In this case, it is preferable to use a 0.1 to 10% aqueous solution of the protease. The powder is preferably a mixture containing 0.1 to 5% protease as well as minerals and carbohydrates for improving the flavor. The contact time may be about 30 minutes to 2 hours.

The present invention is further described below by examples and comparative examples. However, it should be noted that the present invention is not limited to these examples. It is possible to adjust the type and concentration of the enzyme, length of the treatment and other parameters depending on the type of the material. It is also possible to prepare a food product having a specific property that is customized for the specific condition of an elderly person or a person who has difficulty in chewing or swallowing.

### EXAMPLES

The following sensory evaluation method and compressive strength measurement method were used in the Examples and the Comparative Examples.

1. Sensory Evaluation

Ten arbitrarily selected panelists evaluated the shape and the tone of color of each sample by visual inspection. As a texture assessment, the panelists also evaluated smoothness and softness of each sample by eating.

<Evaluation Standards (Evaluation Grade Points)>

1) Shape

5 points: The sample has a natural shape.

4 points: The sample has a nearly natural shape although a small change is observed.

3 points: The sample has a moderately changed shape that is no longer considered natural.

2 points: The sample is showing a disintegration of the shape.

1 point: The sample has disintegrated so substantially that the original shape is not recognizable.

2) Tone of Color

5 points: The sample has an essentially same tone of color as the original material that has been only blanched.

In the following, the original material that has been only blanched (referred to as “original material”) is likewise used as the point of comparison.

4 points: The sample has a sufficiently natural tone of color although slight discoloration or fading is recognizable.

3 points: The sample has moderate discoloration or fading that is recognizable.

2 points: The sample has obvious discoloration or fading.

1 point: The sample has a similar tone of color as the “original material” that has been frozen and thawed three times and stored for 5 days in order to deliberately induce discoloration or fading.

3) Texture

a. Smoothness

5 points: Very smooth

4 points: Sufficiently smooth

3 points: Somewhat rough

2 points: Fairly rough

1 point: Very rough

b. Softness/Hardness

5 points: Very soft

4 points: Sufficiently soft

3 points: Somewhat hard

2 points: Fairly hard

1 point: Very hard

The hardness points in the sensory evaluation and the compressive strength values in the measurement did not correlate sufficiently, because each food material is subject to the preconceived ideas of ‘proper’ hardness (meat is hard, vegetables are softer than meat, etc.) and the types of the materials influence the grading. However, the food products having compressive strengths of approximately 6×10⁵ to 6×10⁶ N/m² were generally evaluated to have a hardness of “3 points”.

c. Smoothness of the Frozen-Dessert Product as it Collapses in the Mouth

5 points: Collapses very smoothly.

4 points: Collapses sufficiently smoothly.

3 points: Collapses with some roughness.

2 points: Collapses with difficulty.

1 point: Does not collapse.

d. Taste

5 points: The taste is very good

4 points: The taste is good

3 points: The taste is neither good nor bad

2 points: The taste is not very good

1 point: The taste is bad

4) Swallowability of the Animal Food Product

5 points: Very easy to wallow

4 points: Easy to swallow

3 points: Neither easy nor hard to swallow

2 points: Somewhat hard to swallow

1 point: Hard to swallow

The “swallowability” is a measure of how easy it is to pass the masticated chunk of food through the pharynx. In the present invention, a food sample was considered to be “easy to swallow” if it could be smoothly swallowed without lingering in the pharynx.

2. Measurement of the Compressive Strength

The compressive strength (N/m²) of the food product was measured by using a rheometer (model RE2-330055 manufactured by Yamaden Co., Ltd.). The plunger used had a diameter of 3 mm, the compression rate was set at 10 mm/sec, and the clearance was set at 30% of the thickness of the specimen. The measurement was made at the temperature of 20±2° C.

The method for testing the foods for the elderly described in “Handling of the Indication Approvals for the Foods for the Elderly (Feb. 23, 1994, Eishin Vol. 15, the Ministry of Health and Welfare of Japan)” was consulted when performing the measurement.

I. Mushroom Food Product

In Examples 1 to 5, mushroom food products suitable for an elderly person or a person who has difficulty in chewing or swallowing were prepared according to the present invention.

### Example 1

Raw Shiitake mushroom was cut into quarters, heated in boiling water for 10 minutes, and frozen.

The material was then immersed in a citric acid buffer (pH 6) containing 1% chitinolytic enzyme (chitinase, SIGMA), thawed at 50° C., and impregnated with the citric acid buffer containing the chitinolytic enzyme for 10 minutes under a reduced pressure of 2,000 Pa. The material was allowed to stand at 50° C. for two hours for undergoing the enzyme treatment. The material was then heated for 10 minutes in a steamer to inactivate the enzyme.

The resulting Shiitake food product (Invention Product 1) had a compressive strength of 3.2×10⁴ N/m².

### Example 2

Dry Shiitake mushroom was cut into quarters, heated for 15 minutes, and frozen.

The material was then immersed in a citric acid buffer (pH 6) containing 1.2% chitinolytic enzyme (chitinase, Kyowakasei Co., Ltd.) and 5% trehalose (Hayashibara Shoji, Inc.), thawed at 50° C., and impregnated with the chitinolytic enzyme for 10 minutes under a reduced pressure of 2,000 Pa. The material was allowed to stand at 50° C. for five hours (enzyme treatment). The material was then heated for 10 minutes in a steamer to inactivate the enzyme. The resulting Shiitake food product of the present invention had a compressive strength of 3.5×10⁴ N/m².

The Shiitake food products obtained in Examples 1 and 2 maintained the original shape of the Shiitake mushroom. Their tone of color and flavor were also similar to those naturally expected in Shiitake. These Shiitake food products were soft enough to be crushed by the gums, formed manageable chunks in the mouth, and could be easily swallowed.

### Example 3

Buna-Shimeji mushroom was cut and heated for 15 minutes in a steamer. The material was immersed in a citric acid buffer (pH 6) containing 1.2% chitinolytic enzyme (chitinase, Kyowakasei Co., Ltd.) and 1% protease (protease P, Amano Enzyme Inc.), and frozen. The material was thawed at 50° C., and impregnated with the chitinolytic enzyme for 10 minutes under a reduced pressure of 500 Pa. The material was allowed to stand at 50° C. for six hours (enzyme treatment). The material was then boiled for 10 minutes to inactivate the enzyme. The resulting Buna-Shimeji food product had a compressive strength of 4.6×10⁴ N/m².

The Buna-Shimeji food product maintained the original shape of the Buna-Shimeji mushroom, and its tone of color and flavor were also similar to those naturally expected in Buna-Shimeji. The Buna-Shimeji food product was soft enough to be crushed by the gums, formed a manageable chunk in the mouth, and could be easily swallowed.

### Example 4

Maitake mushroom was cut and heated for 15 minutes in a pressure cooker. The material was then immersed in a 1% sodium alginate (KIMICA Corporation) solution containing 1.2% chitinolytic enzyme (chitinase, Kyowakasei Co., Ltd.) and 5% trehalose (Hayashibara Shoji, Inc.), and impregnated for 10 minutes under a reduced pressure of 1,000 Pa. The material was allowed to stand at 50° C. for five hours (enzyme treatment). The material was then heated in boiling water for 15 minutes to inactivate the enzyme. The resulting Maitake food product had a compressive strength of 1.9×10⁴ N/m².

The Maitake food product maintained the shape and had a smooth appearance, and its surface and inside were jelly-like. The Maitake food product was soft enough to be crushed by the tongue, formed a manageable chunk in the mouth, and could be easily swallowed.

### Example 5

Raw Shiitake mushroom was sliced, boiled for 10 minutes, and frozen. The material was immersed in a solution containing 1.2% chitinolytic enzyme (chitinase, Kyowakasei Co., Ltd.) and 1% protease (protease M, Amano Enzyme Inc.), and impregnated with the solution for five minutes under a reduced pressure of 500 Pa. The material was allowed to stand at 50° C. for eight hours (enzyme treatment). The material was then heated in boiling water for 15 minutes to inactivate the enzyme. The resulting Shiitake food product had a compressive strength of 1.4×10⁴ N/m².

The Shiitake food product maintained the shape and had the exactly same appearance as sliced Shiitake mushroom. The Shiitake food product was soft enough to be crushed by the tongue, formed a manageable chunk in the mouth, and could be easily swallowed.

### Comparative Example 1

Shiitake mushroom was processed in the same manner as in Example 1 except that 1% pectic enzyme (pectinase, Amano Enzyme Inc.) instead of 1% chitinolytic enzyme (chitinase, SIGMA) was used. The resulting Shiitake food product (Comparison Product 1) had a compressive strength of 9.2×10⁶ N/m².

### Comparative Example 2

Shiitake mushroom was processed in the same manner as in Example 1, except that 1% hemicellulolytic enzyme (hemicellulase, Amano Enzyme Inc.) instead of 1% chitinolytic enzyme (chitinase, SIGMA) was used. The resulting Shiitake food product (Comparison Product 2) had a compressive strength of 7.7×10⁶ N/m².

### Comparative Example 3

Shiitake mushroom was processed in the same manner as in Example 1, except that a mixture of 1% pectic enzyme (pectinase, Amano Enzyme Inc.), 1% hemicellulolytic enzyme (hemicellulase, Amano Enzyme Inc.) and 1% cellulolytic enzyme (cellulase, Amano Enzyme Inc.), instead of 1% chitinolytic enzyme (chitinase, SIGMA) was used. The resulting Shiitake food product (Comparison Product 3) had a compressive strength of 8.1×10⁶ N/m².

### Comparative Example 4

Shiitake mushroom was processed in the same manner as in Example 1, except that the chitinolytic enzyme (chitinase) was not added to the citric acid buffer (pH 6). The resulting Shiitake food product had a compressive strength of 2.4×10⁶ N/m².

The Shiitake food products obtained in the Comparative Examples 1 to 4 maintained their original shapes and had the same tone of color and flavor as those naturally expected in Shiitake. However, these Shiitake food products could not be easily broken up by the teeth, were highly elastic, and were not suitable for easy swallowing.

TABLE 1

| | | Sensory evaluation (evaluation point average) | | | | Physical measurement |
|---|---|---|---|---|---|---|
| | | Appearance | | Texture | | Compressive strength |
| Sample | Enzyme solution | Shape | Tone of color | Smoothness | Softness | (N/m2) |
| Invention | 1% chitinase | 4.8 | 4.7 | 4.8 | 4.7 | 3.2 × 10⁴ |
| Product 1 | | | | | | |
| Comparison | 1% pectic enzyme | 4.6 | 4.5 | 1.4 | 1.2 | 9.2 × 10⁶ |
| Product 1 | | | | | | |
| Comparison | 1% hemicellulolytic enzyme | 4.4 | 4.3 | 1.8 | 1.6 | 7.7 × 10⁶ |
| Product 2 | | | | | | |
| Comparison | 1% pectic enzyme | 4.5 | 4.4 | 1.9 | 1.5 | 8.1 × 10⁶ |
| Product 3 | 1% hemicellulolytic enzyme | | | | | |
| | 1% cellulolytic enzyme | | | | | |

### Comparative Example 5

50 g of dry Shiitake mushroom was soaked and reconstituted in 500 ml water, and then cut into quarters. After the addition of 30 g of sugar and 50 ml of soy sauce, the mixture was heated and cooked for one hour. The cooked Shiitake that resulted had a compressive strength of 2.4×10⁶ N/m².

### Comparative Example 6

Raw Shiitake mushroom was cut into quarters, wrapped in aluminum foil, and heated in a toaster oven (1200 W) for 10 minutes. The cooked Shiitake that resulted had a compressive strength of 8.1×10⁶ N/m².

The cooked Shiitake preparations obtained in Comparative Examples 5 and 6 were soft, but could not be easily crushed by the tongue due to their elasticity.

II. Plant Food Product

In Examples 6 to 13, plant food products suitable for an elderly person or a person who has difficulty in chewing or swallowing were prepared according to the present invention.

### Example 6

Broccoli was cut into about 3 cm cubes and heated in boiling water. The material was then frozen overnight in a household freezer. The frozen broccoli was immersed in a solution containing 1% hemicellulolytic enzyme (Amano Enzyme Inc.) and other ingredients shown in Table 2, and impregnated with the same solution under reduced pressure. The broccoli was removed from the solutions, placed in a sealed container, and subjected to an enzyme treatment at 5° C. for 24 hours or at 40° C. for one hour. The broccoli was then heated at 80° C. for 30 minutes to inactivate the enzyme. The broccoli was then cooled in the Blast Chiller (manufactured by Fukushima Industries Corp.) in such a way that it transited from 0° C. to −5° C. in 10 minutes, cooled further down to −20° C., held at this temperature for one hour, and thawed at room temperature.

The broccoli food products prepared above (Invention Products 2 to 9) according to the present invention and the comparison treatment broccoli preparations (Comparison Products 4 to 15) were subjected to the compressive strength measurement and the sensory evaluation in accordance with the above standards.

TABLE 2

| | Enzyme | | | | Sensory evaluation (point average) | | | | Physical measurement |
|---|---|---|---|---|---|---|---|---|---|
| | concen- | Chelating | Ferulic acid | Reaction | Appearance | | Texture | | Compressive strength |
| | tration | agent | or ferulate | condition | Shape | Tone of color | Smoothness | Softness | (N/m²) |
| Comparison | 0.1% | not | not | 5° C., 24 hours | 4.3 | 2.1 | 2.1 | 1.3 | 9.3 × 10⁶ |
| Product 4 | | added | added | | | | | | |
| Comparison | | | | 40° C., 2 hours | 3.9 | 1.9 | 1.5 | 1.9 | 8.4 × 10⁶ |
| Product 5 | | | | | | | | | |
| Comparison | | | 0.1% | 5° C., 24 hours | 4.5 | 4.8 | 1.6 | 1.7 | 8.7 × 10⁶ |
| Product 6 | | | | | | | | | |
| Comparison | | | | 40° C., 2 hours | 4.2 | 4.2 | 2.1 | 1.9 | 8.2 × 10⁶ |
| Product 7 | | | | | | | | | |
| Comparison | | 0.05M citric | not | 5° C., 24 hours | 4.6 | 2.2 | 4.2 | 4.2 | 3.8 × 10⁴ |
| Product 8 | | acid | added | | | | | | |
| Comparison | | | | 40° C., 2 hours | 4.4 | 2.3 | 4.7 | 4.5 | 3.2 × 10⁴ |
| Product 9 | | | | | | | | | |
| Invention | | | 0.1% | 5° C., 24 hours | 4.9 | 4.7 | 4.2 | 4.9 | 1.9 × 10⁴ |
| Product 2 | | | | | | | | | |
| invention | | | | 40° C., 2 hours | 4.8 | 4.2 | 4.4 | 4.0 | 4.5 × 10⁴ |
| Product 3 | | | | | | | | | |
| Comparison | | 0.05M lactic | not | 5° C., 24 hours | 4.1 | 2.1 | 4.1 | 4.9 | 2.1 × 10⁴ |
| Product 10 | | acid | added | | | | | | |
| Comparison | | | | 40° C., 2 hours | 3.8 | 2.5 | 4.5 | 4.1 | 4.1 × 10⁴ |
| Product 11 | | | | | | | | | |
| Invention | | | 0.1% | 5° C., 24 hours | 4.4 | 4.8 | 4.3 | 4.2 | 3.9 × 10⁴ |
| Product 4 | | | | | | | | | |
| invention | | | | 40° C., 2 hours | 4.2 | 4.1 | 4.2 | 4.8 | 2.4 × 10⁴ |
| Product 5 | | | | | | | | | |
| Comparison | | 0.05M oxalic | not | 5° C., 24 hours | 4.3 | 1.9 | 4.1 | 4.4 | 3.1 × 10⁴ |
| Product 12 | | acid | added | | | | | | |
| Comparison | | | | 40° C., 2 hours | 4.2 | 1.8 | 4.6 | 4.5 | 2.9 × 10⁴ |
| Product 13 | | | | | | | | | |
| Invention | | | 0.1% | 5° C., 24 hours | 4.5 | 4.7 | 4.4 | 4.5 | 2.7 × 10⁴ |
| Product 6 | | | | | | | | | |
| Invention | | | | 40° C., 2 hours | 4.3 | 4.1 | 4.1 | 4.7 | 1.9 × 10⁴ |
| Product 7 | | | | | | | | | |
| Comparison | | 0.05M glycine | not | 5° C. 24 hours | 4.5 | 2.4 | 4.9 | 4.7 | 2.3 × 10⁴ |
| Product 14 | | | added | | | | | | |
| Comparison | | | | 40° C., 2 hours | 4.4 | 2.6 | 4.5 | 4.3 | 4.1 × 10⁴ |
| Product 15 | | | | | | | | | |
| Invention | | | 0.1% | 5° C., 24 hours | 4.7 | 4.9 | 4.1 | 4.7 | 1.9 × 10⁴ |
| Product 8 | | | | | | | | | |
| Invention | | | | 40° C., 2 hours | 4.7 | 4.1 | 4.4 | 4.4 | 3.6 × 10⁴ |
| Product 9 | | | | | | | | | |

The measurement demonstrated that the broccoli food products (Invention Products 2 to 9) of the present invention had compressive strengths of 5×10⁴ N/m² or lower, and the sensory evaluation confirmed that they had smoothness, softness, and no discoloration. On the other hand, the comparison treatment broccoli preparations (Comparison Products 4 to 15) all showed less smoothness, less softness, and discoloration, and their colors and textures were different from those seen in the broccoli food products of the present invention.

### Example 7

Broccoli food products (Invention Products 10 to 12) according to the present invention and comparison treatment broccoli preparations (Comparison Products 16 to 18) were produced in the same manner as in Example 6 except that, in the use of the Blast Chiller (Fukushima Industries Corp.), the cooling conditions shown in Table 3 were employed.

The temperature differences in the different cooling conditions were monitored by using a temperature sensor inserted at the center of the broccoli.

After the thawing step, the broccoli food products were subjected to the compressive strength measurement and the sensory evaluation in accordance with the above standards. The results are shown in Table 3.

TABLE 3

| | Cooling condition | Sensory evaluation (evaluation point average) | | | | Physical measurement |
|---|---|---|---|---|---|---|
| | Time taken in the | Appearance | | Texture | | Compressive strength |
| | 0° C. to −5° C. range (min) | Shape | Tone of color | Smoothness | Softness | (N/m2) |
| Invention | 5 | 4.5 | 4.7 | 4.8 | 4.7 | 2.2 × 10⁴ |
| Product 10 | | | | | | |
| Invention | 12 | 4.6 | 4.8 | 4.1 | 4.4 | 2.8 × 10⁴ |
| Product 11 | | | | | | |
| Invention | 15 | 4.2 | 4.5 | 4.5 | 4.0 | 3.8 × 10⁴ |
| Product 12 | | | | | | |
| Comparison | 18 | 4.3 | 4.1 | 2.8 | 4.0 | 4.1 × 10⁴ |
| Product 16 | | | | | | |
| Comparison | 20 | 4.0 | 3.9 | 2.5 | 3.1 | 4.8 × 10⁴ |
| Product 17 | | | | | | |
| Comparison | 60 | 4.4 | 3.6 | 1.2 | 1.3 | 5.0 × 10⁵ |
| Product 18 | | | | | | |

The measurement demonstrated that the broccoli food products (Invention Products 10 to 12) of the present invention all had compressive strengths of 5×10⁴ N/m² or lower, and the sensory evaluation confirmed that they had smoothness, softness, and no discoloration. On the other hand, the comparison treatment broccoli preparations (Comparison Products 16 to 18) all showed less smoothness and less softness and were not suitable for an elderly person or a person who has difficulty in chewing or swallowing.

### Example 8

Apple was peeled, cored, cut into twelve equal pieces (total 20 g), and frozen overnight in a household freezer. The frozen apple was immersed in the solution containing 0.1% hemicellulolytic enzyme (Amano Enzyme Inc.) and the functional nutrient components (nutrients) shown in Table 4, and impregnated with the solution under reduced pressure. The material was then removed from the solution, placed in a sealed container, and subjected to the enzyme treatment at 5° C. for 24 hours. After the material was heated at 80° C. for 30 minutes to inactivate the enzyme, the material was cooled in the Blast Chiller (manufactured by Fukushima Industries Corp.) in such a way that it transited from 0° C. to −5° C. in five minutes, cooled further down to −20° C., held at −20° C. for one hour, and thawed at room temperature.

The apple food product of the present invention thus produced was subjected to the sensory evaluation in accordance with the above standards, and the functional enhancement components per piece of the apple were analyzed. The results are shown in Table 4.

TABLE 4

| | |
|---|---|
| Concentration of functional | Average analytical value |
| enhancement component | (introduced amount per piece) |

| | | |
|---|---|---|
| 25 g/100 ml Arginine | 0.65 | g |
| 40 g/100 ml Glutamine | 1.04 | g |
| 10 mg/100 ml Copper gluconate | 0.52 | mg |
| 100 mg/100 ml Zinc gluconate | 4.81 | mg |
| 20 mg/100 ml Vitamin B1 | 0.47 | mg |
| 40 μg/100 ml Vitamin B12 | 0.75 | μg |
| 10 g/100 ml Ascorbic acid | 0.52 | g |

The measurement demonstrated that the apple food product of the present invention had a compressive strength of 1.5×10⁴ N/m², and the sensory evaluation confirmed that it had a smooth texture and no discoloration. Each functional enhancement component was contained in the apple. This confirms that a nutritionally-enhanced apple food product can be obtained.

### Example 9

Carrot was peeled, cut into 1 cm-thick slices, and heated in boiling water for five minutes. The material was then frozen overnight in a household freezer. The frozen carrot was immersed in a solution containing 1% hemicellulolytic enzyme (Amano Enzyme Inc.), 0.05M citric acid, 0.1% of ferulic acid, 25% sucrose, and 0.1% lemon flavor, and impregnated with this solution under reduced pressure. The carrot was then removed from the solution, placed in a sealed container, and subjected to the enzyme treatment at 5° C. for 24 hours. After the material was heated at 80° C. for 30 minutes to inactivate the enzyme, the material was cooled in the Blast Chiller (manufactured by Fukushima Industries Corp.) in such a way that it transited from 0° C. to −5° C. in five minutes, and cooled further down to −20° C. to produce a carrot food product (Invention Product 13) of the present invention.

The comparison treatment carrot preparations (Comparison Products 19 and 20) were produced in the same manner as described above, except that the citric acid (Comparison Product 19) or the enzyme (Comparison Product 20) was omitted from the solution. The carrot food products were subjected to the sensory evaluation in accordance with the above standards.

The texture of the carrot food products was evaluated when the frozen samples were allowed to melt in the mouth.

The results of the sensory evaluation are shown in Table 5. The carrot food product (Invention Product 13) of the present invention collapsed more smoothly in the mouth and tasted better, compared to the comparison treatment carrots (Comparison Products 19 and 20).

TABLE 5

| | Component | | | Sensory evaluation (point average) | | | | Physical measurement |
|---|---|---|---|---|---|---|---|---|
| | 1% | 0.1% | 0.05M | Appearance | | Texture | | Compressive strength |
| | pectinase | ferulic acid | citric acid | Shape | Tone of color | Smoothness | Softness | (N/m2) |
| Invention | added | added | added | 4.7 | 4.6 | 4.7 | 4.8 | 1.9 × 10⁴ |
| Product 13 | | | | | | | | |
| Comparison | added | not | added | 4.6 | 1.8 | 1.6 | 1.5 | 2.1 × 10⁶ |
| Product 19 | | added | | | | | | |
| Comparison | added | added | not | 4.3 | 4.4 | 1.5 | 1.7 | 3.4 × 10⁶ |
| Product 20 | | | added | | | | | |

### Example 10

Blanched carrot was frozen at −15° C., immersed and thawed in a warm (40° C.) 1% pectic enzyme solution (pectinase, Amano Enzyme Inc.) containing ferulic acid and citric acid, decompressed (5300 Pa (40 mmHg)) for five minutes by using a vacuum pump, and allowed to stand for 60 minutes (enzyme treatment). After the carrot material was heated at 80° C. for 30 minutes to inactivate the enzyme, the material was cooled in the Blast Chiller (manufactured by Fukushima Industries Corp.) in such a way that it transited from 0° C. to −5° C. in five minutes, further cooled down to −20° C. quickly, stored at −18° C. for one week, and thawed naturally at room temperature.

### Comparative Example 7

Carrot food products were produced in same manner as in Example 10, except that the following changes were made.

1) A 1% pectic enzyme solution that did not contain ferulic acid and citric acid was used (Comparison Product 21).

2) A 1% pectic enzyme solution that contained ferulic acid but not citric acid was used (Comparison Product 22).

3) A 1% pectic enzyme solution that contained ferulic acid, and 0.05M acetic acid instead of 0.05M citric acid, was used (Comparison Product 23).

The carrot food product (Invention Product 14) of the present invention produced above and the comparison treatment carrot preparations (Comparison Products 21 to 23) were subjected to the compressive strength measurement and the sensory evaluation in accordance with the above standards. The results are shown in Table 6.

TABLE 6

| | Component | | | Sensory evaluation (evaluation point average) | | | | Physical measurement |
|---|---|---|---|---|---|---|---|---|
| | 1% | 0.1% | 0.05M | Appearance | | Texture | | Compressive strength |
| | pectinase | ferulic acid | citric acid | Shape | Tone of color | Smoothness | Softness | (N/m2) |
| Invention | added | added | added | 4.7 | 4.6 | 4.7 | 4.8 | 1.9 × 10⁴ |
| Product 14 | | | | | | | | |
| Comparison | added | not | not | 4.6 | 1.8 | 1.6 | 1.5 | 2.1 × 10⁶ |
| Product 21 | | added | added | | | | | |
| Comparison | added | added | not | 4.3 | 4.4 | 1.5 | 1.7 | 3.4 × 10⁶ |
| Product 22 | | | added | | | | | |
| Comparison | added | added | 0.05M | 4.5 | 4.3 | 2.2 | 1.9 | 1.1 × 10⁶ |
| Product 23 | | | acetic acid added | | | | | |

The measurement demonstrated that the carrot food product (Invention Product 14) of the present invention had a compressive strength of 5×10⁴ N/m² or lower, and the sensory evaluation confirmed that it maintained the natural shape and color of the carrot, had a smooth texture, and was soft enough to be easily crushed by the gums or the tongue. On the other hand, the Comparison Product 21 had a compressive strength far above 5×10⁴ N/m², and even though its shape was satisfactory, it suffered discoloration and did not preserve the natural tone of color. The Comparison Product 21 also had an elastic, sponge-like or rubbery texture, lacked smoothness, and could not be crushed by the gums or the tongue due to its hardness.

The Comparison Products 22 and 23 also had compressive strengths far above 5×10⁴ N/m², and even though their shapes and colors were satisfactory, their textures were similar to the Comparison Product 21.

These results suggest the following. When impregnating the carrot material with ferulic acid together with the enzyme, a change in color (discoloration or fading) could be prevented, but smoothness and softness are lost. Smoothness and softness can be maintained with an organic acid having a chelating effect, such as citric acid, but not with an organic acid that does not have a chelating effect, such as acetic acid. Therefore, it is important to use the enzyme, ferulic acid, and the chelating agent in combination, in order to obtain the plant food product according to the present invention.

III. Animal Food Product

In Examples 11 to 14, animal food products that are suitable for an elderly person or a person who has difficulty in chewing or swallowing were produced according to the present invention.

### Example 11

Pork leg meat (about 10 mm-thick slice) was subjected to the water removal treatment with a combination of method and condition shown in Table 7, and the weight reduction rate (%) was determined for each sample. The material was then immersed in a 1% protease solution (Protease P “Amano” 3G, Amano Enzyme Inc.) and allowed to stand for 10 minutes under a reduced pressure of 2,000 Pa. The pork leg meat was then subjected to the enzyme treatment at 45° C. for 30 minutes in an incubator, and heated at 80° C. for one hour to inactivate the enzyme, to produce the pork leg meat food products (Invention Products 15 to 18).

### Comparative Example 8

Comparison treatment pork food products were prepared in the same manner as in Example 11, except that the following changes were made.

1) Pork leg meat was not subjected to the water removal treatment (Comparison Product 24).

2) The enzyme reaction was extended to three hours (Comparison Product 25).

The pork leg meat food products (Invention Products 15 to 18) of the present invention and the comparison treatment pork leg preparations (Comparison Products 24 and 25) produced above were subjected to the compressive strength measurement and the sensory evaluation in accordance with the above standards. The results are shown in Table 7.

TABLE 7

| | | | | | | | | | Physical |
|---|---|---|---|---|---|---|---|---|---|
| | | | Enzyme | Water | | | | | measurement |
| | | | concen- | Reduction | Sensory evaluation (evaluation point average) | | | | Compressive |
| | | | tration | rate | Appearance | | Tone of color | | strength |
| Sample | Water removal treatment/condition | | (%) | (%) | Shape | Tone of color | Smoothness | Softness | (N/m²) |
| Invention | Heat | Put in a sealed container | 1% | 25.1 | 4.4 | 4.3 | 4.1 | 4.6 | 4.4 × 10⁴ |
| Product 15 | treatment | in 70° C. water for 10 min | | | | | | | |
| Invention | Hot-blast | 80° C. air blowing | 1% | 37.4 | 4.2 | 3.8 | 4.0 | 4.3 | 4.7 × 10⁴ |
| Product 16 | drying | for 2 hours | | | | | | | |
| Invention | Cold-blast | 10° C. air blowing | 1% | 15.2 | 4.7 | 4.6 | 3.8 | 4.0 | 5.0 × 10⁴ |
| Product 17 | drying | for 6 hours | | | | | | | |
| Invention | Freeze- | Frozen and freeze-dried | 1% | 69.8 | 4.9 | 4.8 | 4.6 | 4.8 | 4.2 × 10⁴ |
| Product 18 | drying | For 72 hours | | | | | | | |
| Comparison | No | (Water removal treatment | 1% | 0.0 | 4.6 | 4.7 | 1.0 | 1.6 | 1.1 × 10⁶ |
| Product 24 | treatment | was omitted) | | | | | | | |

| | | | | | | | | |
|---|---|---|---|---|---|---|---|---|
| Comparison | Heat | Put in a sealed container | 1% | 24.8 | 2.6 | 3.2 | Could not | 4.5 × 10³ |
| Product 25 | treatment | in 70° C. water for 10 min | | | | | be evaluated | |

Water reduction rate = [(weight before treatment − weight after treatment)/weight before treatment] × 100

The pork leg food products (Invention Products 15 to 18) of the present invention each had a weight reduction rate ([(weight before water removal treatment−weight after water removal treatment)/weight before water removal treatment]×100) of 15% or higher, suggesting that a sufficient amount of water was removed for enabling extensive infiltration of the protease solution to soften the pork meat. The measurement demonstrated that the pork leg food products (Invention Products 15 to 18) of the present invention had compressive strengths of 5×10³ to 5×10⁴ N/m², and the sensory evaluation confirmed that they maintained their meaty shape, had smooth texture and were soft enough to be crushed by the gums. The Comparison Product 24 that had not been subjected to the water removal treatment had a compressive strength higher than 5×10⁴ N/m²; it could not be crushed by the gums, and it did not have a smooth texture. The Comparison Product 25 that had been subjected to the enzyme reaction for three hours failed to maintain the meaty shape, and because it was partially liquefied, it did not have an appearance appropriate for a food product and its smoothness could not be evaluated.

### Example 12

Pork fillet (about 10 mm-thick slice) was subjected to a water removal treatment for three days in a freeze-dryer. The water originally contained in the meat was sublimed this way and the weight of the material was reduced by about 70% based on the fresh weight. The material was then immersed in a 1.2% protease solution (Protease P “Amano” 3G; Amano Enzyme Inc.) containing a thickener shown in Table 8, and subjected to a decompression treatment for 20 minutes under a reduced pressure of 2,000 Pa. The material was then allowed to stand at 45° C. for 30 minutes in an incubator (enzyme treatment). The material was then heated at 80° C. for one hour to inactivate the enzyme to produce the pork fillet food products (Invention Products 19 to 22). Another pork fillet food product (Invention Product 23) was obtained in the same manner as described above except that the thickener was not used.

### Comparative Example 9

A comparison treatment pork fillet preparation (Comparison Product 26) was produced in the same manner as the Invention Product 22 in Example 12, except that a solution containing only the thickener, and not the enzyme, was used.

The pork fillet food products (Invention Products 19 to 23) of the present invention and the comparison treatment pork fillet preparation (Comparison Product 26) produced above were subjected to the compressive strength measurement and the sensory evaluation in accordance with the above standards. These results and the thickener content of each food product, which is expressed as a dietary fiber analytical value (enzyme-gravimetric method), are shown in Table 8.

TABLE 8

| | | | | | | | | Physical | Dietary fiber analysis |
|---|---|---|---|---|---|---|---|---|---|
| | Enzyme | | Sensory evaluation (evaluation point average) | | | | | measurement | (g/100 g) |
| | concen- | | Appearance | | Texture | | | Compressive | (Enzyme-gravimetric |
| Sample | tration | Thickener | Shape | Tone of color | Smoothness | Softness | Swallowability | strength (N/m²) | method) |
| Invention | 1.2 | 0.5% | 4.8 | 4.5 | 4.6 | 4.3 | 4.5 | 4.2 × 10⁴ | 0.9 |
| Product 19 | | carrageenan | | | | | | | |
| Invention | 1.2 | 0.5% | 4.8 | 4.7 | 4.5 | 4.6 | 4.1 | 4.0 × 10⁴ | 0.5 |
| Product 20 | | sodium | | | | | | | |
| | | alginate | | | | | | | |
| Invention | 1.2 | 0.5% | 4.7 | 4.6 | 4.7 | 4.8 | 4.4 | 3.8 × 10⁴ | 0.8 |
| Product 21 | | locust | | | | | | | |
| | | bean gum | | | | | | | |
| Invention | 1.2 | 0.5% | 4.6 | 4.4 | 4.4 | 4.6 | 4.8 | 4.1 × 10⁴ | 1.1 |
| Product 22 | | pectin | | | | | | | |
| Invention | 1.2 | none | 4.5 | 4.5 | 4.1 | 4.2 | 2.8 | 4.6 × 10⁴ | 0.0 |
| Product 23 | | | | | | | | | |
| Comparison | 0.0 (no | 0.5% | 4.6 | 4.4 | 0.8 | 1.4 | 1.1 | 1.6 × 10⁶ | 1.0 |
| Product 26 | enzyme | pectin | | | | | | | |
| | added) | | | | | | | | |

The pork fillet food products (Invention Products 19 to 23) of the present invention each had a compressive strength of 5×10⁴ N/m² or lower, had a smooth texture felt in the mouth, and were soft enough to be crushed by the gums.

The pork fillet food products that had been impregnated with a thickener (Invention Products 19 to 22) could be much more easily swallowed as compared with the pork fillet food product that had not been impregnated with a thickener (Invention Product 23), suggesting that the addition of a thickener helps to further improve the swallowability of the prepared food product. On the other hand, the Comparison Product 26 that had not been impregnated with the enzyme had a compressive strength higher than 5×10⁴ N/m² and was inferior in terms of smoothness and swallowability. Since the Comparison Product 26 contained the same type and amount of thickener as the Invention Product 21, it was confirmed that a product of the present invention could not be obtained by infiltrating only a thickener.

### Example 13

Chicken breast meat (about 10 mm-thick slice) was subjected to a water removal treatment for three days in a freeze-dryer to sublime the water originally contained in the meat. The weight of the material was thus reduced by about 70% based on the fresh weight. The material was humidified for two hours by using a steam convection system at a temperature of 60° C. and humidity of 100%. The material was then immersed in a 1% protease solution (Protease P “Amano” 3G; Amano Enzyme Inc.) at room temperature, and subjected to a decompression treatment for 20 minutes under a reduced pressure of 2,000 Pa. The material was then allowed to stand at 45° C. for 30 minutes in the steam convection system (enzyme treatment). The material was then heated (cooked) at 80° C. for 40 minutes to inactivate the enzyme to produce a chicken breast meat food product (Invention Product 24).

### Comparative Example 10

A chicken breast meat food product (Invention Product 25) was produced in the same manner as in Example 13, except that the humidifying/warming treatment was omitted after the freeze-drying. A comparison treatment chicken breast meat preparation (Comparison Product 27) was also produced in the same manner as in Example 13, except that the enzyme was not used.

The chicken breast meat food products (Invention Products 24 and 25) of the present invention and the comparison treatment chicken breast meat preparation (Comparison Product 27) thus produced were subjected to the compressive strength measurement and the sensory evaluation in accordance with the above standards. The results are shown in Table 9.

TABLE 9

| | | | Sensory evaluation (point average) | | | | Physical measurement |
|---|---|---|---|---|---|---|---|
| | Humidifying/warming | Enzyme | Appearance | | Texture | | Compression strength |
| Sample | treatment | concentration | Shape | Tone of color | Smoothness | Softness | (N/m²) |
| Invention | 100% humidity. | 1% | 4.9 | 4.9 | 4.9 | 4.9 | 3.6 × 10⁴ |
| Product 24 | 60° C., 2 hr | | | | | | |
| Invention | none | 1% | 4.7 | 4.6 | 4.1 | 4.2 | 4.8 × 10⁴ |
| Product 25 | | | | | | | |
| Comparison | 100% humidity, | 0% | 4.6 | 4.8 | 0.9 | 1.4 | 1.2 × 10⁶ |
| Product 27 | 60° C., 2 hr | (no enzyme added) | | | | | |

The measurement demonstrated that the chicken breast meat food products (Invention Products 24 and 25) of the present invention each had a compressive strength of 5×10⁴ N/m² or lower, had a smooth texture felt in the mouth, and were soft enough to be crushed by the gums. The Invention Product 24 that had been humidified after freeze-drying had a smoother texture. The Comparison Product 27 that had not been impregnated with the enzyme had a compressive strength higher than 5×10⁴ N/m², and had markedly poor smoothness and texture. These results suggest that a food product according to the present invention that is suitable for an elderly person or a person who has difficulty in chewing or swallowing cannot be produced by performing only the humidifying treatment.

### Example 14

1. Pre-Treatment

1) Enzyme Treatment of the Surface of the Material

Prior to the water removal treatment, salmon (about 20 mm-thick slice) was immersed in a 1% protease (Protease P “Amano” 3G; Amano Enzyme Inc.) aqueous solution, and allowed to stand at 4° C. for two hours.

2) Water Removal Treatment

The material was then subjected to the water removal treatment under the conditions shown in Table 10 (Invention Products 26 and 28). As a comparison, the material that had not been subjected to the pre-treatment described in 1) was subjected to the water removal treatment under the conditions shown in Table 10 (Invention Products 27 and 29).

As shown in Table 10, the water removal rate was significantly improved by the pre-treatment of the surface of the material with the enzyme. This was due to the fact that the protease had digested the surface of the material to form minute openings in the tissue, improving the drying efficiency and the rate of the water removal.

2. Preparation of Salmon Food Product

The animal material (salmon) pre-treated as described in 1) was immersed in an enzyme solution containing 1.0% protease (Protease P “Amano” 3G; Amano Enzyme Inc.) and 0.5% locust bean gum, and subjected to a decompression treatment for 20 minutes under a reduced pressure of 2,000 Pa. The material was then subjected to an enzyme treatment at 45° C. for 30 minutes in an incubator, and heated at 80° C. for one hour to inactivate the enzyme, to produce the salmon food products (Invention Products 26 and 28 with the surface pre-treatment, and Invention Products 27 and 29 without the surface pre-treatment).

The salmon food products were subjected to the compressive strength measurement and the sensory evaluation in accordance with the above standards. The results are shown in Table 10.

TABLE 10

| | | | Pretreatment | Weight | | | | | |
|---|---|---|---|---|---|---|---|---|---|
| | | | (Immersion | reduction | Sensory evaluation (point average) | | | | Physical measurement |
| | Water removal treatment | | in enzyme | rate | Appearance | | Texture | | Compressive strength |
| Sample | Method | Condition | solution) | (%) | Shape | Tone of color | Smoothness | Softness | (N/m²) |
| Invention | Heat | Put in a sealed | yes | 30.2 | 4.7 | 4.6 | 4.9 | 4.9 | 2.5 × 10⁴ |
| Product 26 | treatment | container in 70° C. | | | | | | | |
| Invention | | water for 10 min | no | 25.1 | 4.8 | 4.7 | 4.1 | 4.6 | 3.8 × 10⁴ |
| Product 27 | | | | | | | | | |
| Invention | Hot-blast | 80° C. air blowing | yes | 45.9 | 4.5 | 4.4 | 4.9 | 4.8 | 2.8 × 10⁴ |
| Product 28 | drying | for 2 hr | | | | | | | |
| Invention | | | no | 37.4 | 4.7 | 4.6 | 4.0 | 4.4 | 3.9 × 10⁴ |
| Product 29 | | | | | | | | | |

Weight reduction rate = [(weight before water removal − weight after water removal)/weight before water removal] × 100

The salmon food products (Invention Products 26, 27, 28 and 29) of the present invention had compressive strengths within the range of 5×10³ to 5×10⁴ N/m², maintained the original shape of the salmon meat, had a smooth texture felt in the mouth, and were soft enough to be crushed by the gums. The Invention Products 26 and 28 which had undergone the surface pre-treatment with the enzyme were superior in terms of smoothness.

The results suggest that the water removal rate of the food material was increased by the preceding enzyme treatment of the surface of the material, which also improved the efficiency of the subsequent infiltration of the enzyme solution.

1. A food product that is suitable for an elderly person or a person who has difficulty in chewing or swallowing, obtainable by impregnating and treating a food material with an enzyme, said food product having a smooth texture and sufficient softness to be crushed by the gums or tongue in the mouth, while maintaining the natural shape and tone of color of the material.

2. The food product suitable for an elderly person or a person who has difficulty in chewing or swallowing according to claim 1, wherein said food product has a compressive strength of 5×10⁴ N/m² or lower when measured at a compression rate of 10 mm/sec by using a plunger with a diameter of 3 mm and setting the clearance at 30% of the thickness of the specimen.

3. The food product suitable for an elderly person or a person who has difficulty in chewing or swallowing according to claim 1, wherein said food product has a smooth texture and sufficient softness to be crushed by the gums or tongue in the mouth while maintaining the natural shape and tone of color of the material, even when it is further frozen and thawed.

4. The food product suitable for an elderly person or a person who has difficulty in chewing or swallowing according to claim 1, wherein said food product is a mushroom food product, a plant food product, or an animal food product.

5. The mushroom food product according to claim 1, obtainable by impregnating and treating a mushroom material with a chitinolytic enzyme.

6. The mushroom food product according to claim 5, obtainable by impregnating and treating the mushroom material with an enzyme agent comprising a chitinolytic enzyme and a protease.

7. The plant food product according to claim 1, obtainable by impregnating and treating a plant material with an enzyme, ferulic acid or a salt thereof, and a substance having a chelating effect.

8. The plant food product according to claim 7, obtainable with an additional quick-freezing process.

9. The plant food product according to claim 7, wherein the enzyme is at least one enzyme selected from a cellulolytic enzyme, a protopectic enzyme, a pectic enzyme, and a hemicellulolytic enzyme.

10. The plant food product according to claim 7, wherein the substance having a chelating effect is at least one substance selected from citric acid, lactic acid, oxalic acid, and glycine.

11. The plant food product according to claim 7, wherein the material is quickly frozen down in such a way that it transits from 0° C. to −5° C. within 15 minutes before it is further cooled down to −18° C. or below.

12. The plant food product according to claim 7, wherein the plant material is impregnated with an aqueous solution that contains 0.01 to 10% enzyme and 0.1 to 20% ferulic acid or salt thereof.

13. The animal food product according to claim 1, obtainable by removing water from an animal material consisting of meat or seafood, by 15% or more based on the fresh weight of the material, and impregnating and treating the material with an enzyme.

14. The animal food product according to claim 13, obtainable by removing water from an animal material consisting of meat or seafood, by 15% or more based on the fresh weight of the material, then wetting the material in an environment having a temperature of 50 to 100° C. and humidity of 70% or higher, and impregnating and treating the material with an enzyme.

15. The animal food product according to claim 13, wherein the surface of the animal material is pre-digested with an enzyme solution or enzyme-containing powder to generate minute openings thereon.

16. The animal food product according to claim 13, wherein the enzyme is a protease.

17. The food product suitable for an elderly person or a person who has difficulty in chewing or swallowing according to claim 1, obtainable by impregnating and treating the material with a solution that contains a thickener in addition to the enzyme.

18. The food product suitable for an elderly person or a person who has difficulty in chewing or swallowing according to claim 17, wherein the thickener is at least one thickener selected from alginate, pectin, xanthan gum, guar gum, locust bean gum, carrageenan, glucomannan, curdlan, and starch.

19. The food product suitable for an elderly person or a person who has difficulty in chewing or swallowing according to claim 17, wherein the solution that contains the thickener additionally contains trehalose.

20. The food product suitable for an elderly person or a person who has difficulty in chewing or swallowing according to claim 1, wherein the said food product is a mushroom food product, a plant food product or an animal food product that is impregnated with a functional food component for nutritional enhancement.

21. A method of producing a mushroom food product comprising the step of transforming the surface and the inside of a mushroom material into a soft or gel-like matter by impregnating and treating the mushroom fruit body with an enzyme or an enzyme and a thickener.

22. The method of producing a mushroom food product according to claim 21, wherein the enzyme is a chitinolytic enzyme.

23. A method of producing a plant food product comprising the steps of impregnating a plant material with an enzyme, ferulic acid or a salt thereof, and a substance having a chelating effect, and quick-freezing the said plant material.

24. The method of producing a plant food product according to claim 23, wherein the quickly-freezing is performed in such a way that the plant material transits from 0° C. to −5° C. within 15 minutes before it is further cooled down to −18° C. or below.

25. The method of producing a plant food product according to claim 23, wherein the plant material is impregnated with an aqueous solution that contains 0.01 to 10% enzyme and 0.1 to 20% ferulic acid or salt thereof.

26. The method of producing a plant food product according to claim 23, wherein the enzyme is at least one enzyme selected from a cellulolytic enzyme, a protopectic enzyme, a pectic enzyme, and a hemicellulolytic enzyme.

27. A method of producing an animal food product comprising the steps of removing water from an animal material consisting of meat or seafood, by 15% or more based on the fresh weight of the material, and subsequently impregnating and treating the material with an enzyme.

28. The method of producing an animal food product according to claim 27, comprising the steps of removing water from an animal material consisting of meat or seafood, by 15% or more based on the fresh weight of the material, then wetting the material in an environment having a temperature of 50 to 100° C. and humidity of 70% or higher, and impregnating the material with an enzyme.

29. The method of producing an animal food product according to claim 27, wherein the material is impregnated with the enzyme and a thickener.

30. The method of producing an animal food product according to claim 27, wherein the surface of the animal material is pre-digested with an enzyme solution or enzyme-containing powder to generate minute openings thereon.

31. The method of producing an animal food product according to claim 27, wherein the enzyme is a protease.
